(19) United States
(12) Patent Application Publication
(10) Pub. No.: US 2026/0084381 A1
(43) Pub. Date: Mar. 26, 2026

(54) DIRECT BONDING OF POLYMERS TO LASER-GENERATED SURFACE STRUCTURES

(71) Applicant: NUtech Ventures, Lincoln, NE (US)

(72) Inventors: Lucia Fernandez Ballester, Lincoln, NE (US); Craig Zuhlke, Lincoln, NE (US)

(21) Appl. No.: 19/339,047

(22) Filed: Sep. 24, 2025

Related U.S. Application Data
(60) Provisional application No. 63/698,331, filed on Sep. 24, 2024.

(51) Int. Cl. B29C 65/44; B23K 26/352; B29C 65/02

(52) U.S. Cl. CPC B29C 65/44; B23K 26/355; B29C 65/022

(57) ABSTRACT

A method of joining a base component with a polymer may include irradiating the base component with laser illumination, where one or more properties of the laser illumination is selected to induce surface structures on a surface of the base component that wick a polymer component into cavities of the surface structures. For solid polymers, the method may include heating a surface of the polymer component to create a molten layer, then joining the surface of the polymer component with the surface of the base component, where the molten layer wicks into the cavities to bond the components. For liquid polymer components including polymers or polymer precursors in a liquid state, the method may include joining the liquid polymer component with the surface of the base component, where the liquid polymer component wicks into the cavities, followed by curing or drying the polymer component to bond the components.

### CROSS-REFERENCE TO RELATED APPLICATIONS

The present application claims the benefit under 35 U.S.C. § 119 (e) of U.S. Provisional Application Ser. No. 63/698,331 filed on Sep. 24, 2024, which is incorporated herein by reference in its entirety.

### TECHNICAL FIELD

The present disclosure relates generally to bonding polymer to other materials and, more particularly, to generating surface structures on a surface to induce wicking of a polymer material to bond the polymer material to the surface.

### BACKGROUND

Bonding of lightweight polymers to metals is critical for manufacturing hybrid polymer-metal elements, which are highly desirable as a replacement of all-metal load-bearing structures due to the potential decrease in energy consumption in cars, planes, and ships, and during transport of material goods such as phones, electronics, appliances, etc. However, manufacturing and use of hybrid polymer-metal structures is currently limited by poor adhesion between the polymer and other components, which often causes failure of the bonded interface even under mild mechanical loading.

Poor adhesion is particularly exacerbated in the case of polyolefin polymers, which represent a large share of polymer use worldwide and are widely applied across automotive, biomedical, fiber, and packaging industries. Polyolefins exhibit extremely low surface energies, which makes them extremely difficult to bond to other materials. While the advantageous final properties of polyolefins combined with relatively low costs account for their ubiquitous use across diverse industries, poor adhesion of polyolefins has become a barrier for their application in hybrid polymer materials.

### SUMMARY

In some embodiments, a method is provided. The method may include irradiating a base component with one or more laser beams, where one or more properties of the one or more laser beams are selected to induce surface structures on a surface of the base component that wick a polymer component in a molten state into cavities of the surface structures. The method may include heating a surface of the polymer component to create a molten layer. The method may include joining the surface of the polymer component with the surface of the base component, where the molten layer of the polymer component wicks into the cavities of the surface structures of the base component to bond the polymer component to the base component.

In some embodiments, the polymer component may include at least one of polypropylene, a polyolefin or a thermoplastic.

In some embodiments, the base component may include at least one of a metal, a ceramic, a dielectric, or a semiconductor.

In some embodiments, heating the surface of the polymer component to create the molten layer may be performed prior to joining the surface of the polymer component with the surface of the base component.

In some embodiments, heating the surface of the polymer component to create the molten layer may be performed after joining the surface of the polymer component with the surface of the base component.

In some embodiments, joining the surface of the polymer component with the surface of the base component may include contacting the polymer component with the base component using a pressure equal to or less than 100 bars.

In some embodiments, joining the surface of the polymer component with the surface of the base component may include contacting the polymer component with the base component using a pressure equal to or less than 2 bars.

In some embodiments, the surface structures may include at least some features with dimensions smaller than 1000 micrometers and at least some features with dimensions smaller than 1000 nanometers.

In some embodiments, the surface structures may be formed from at least one of a same material as the base component or an oxide of the material of the base component.

In some embodiments, irradiating the base component with the one or more laser beams may include irradiating the base component with the one or more laser beams at a non-normal incidence angle and a selected azimuth direction, where at least some of the surface structures are oriented in a direction of the non-normal incidence angle.

In some embodiments, irradiating the base component with the one or more laser beams may include irradiating a first portion of the base component with the one or more laser beams having a first set of illumination properties to form a first pattern of the surface structures and irradiating a second portion of the base component with the one or more laser beams having a second set of illumination properties to form a second pattern of the surface structures.

In some embodiments, the first set of illumination properties may be selected to provide that the first pattern of surface structures has a first set of bonding properties, where the second set of illumination properties is selected to provide that the second pattern of surface structures has a second set of bonding properties.

In some embodiments, the first set of bonding properties and the second set of bonding properties may differ by at least one of shear strength, tensile strength, or torsion strength.

In some embodiments, a method is provided. The method may include irradiating a base component with one or more laser beams, where one or more properties of the one or more laser beams are selected to induce surface structures on a surface of the base component that wick a polymer component into cavities of the surface structures, where the polymer component includes at least one of a polymer or a precursor to the polymer in a liquid state. The method may include joining the polymer component with the surface of the base component, where the polymer component in the liquid state wicks into the cavities of the surface structures of the base component. The method may include at least one of curing or drying the polymer component while the polymer component is within the cavities of the surface structures to bond the polymer component to the base component.

In some embodiments, at least one of curing or drying the polymer component while within the cavities of the surface structures may include exposing the polymer component to at least one of electromagnetic radiation, heat, pressure, or a catalyst.

In some embodiments, the base component may include at least one of a metal, a ceramic, a dielectric, or a semiconductor.

In some embodiments, the polymer component may include at least one of a thermoset, a paint, a thermoplastic, or an epoxy.

In some embodiments, irradiating the base component with the one or more laser beams may include irradiating the base component with the one or more laser beams at a non-normal incidence angle and a selected azimuth direction, where at least some of the surface structures are oriented in a direction of the non-normal incidence angle.

In some embodiments, irradiating the base component with the one or more laser beams may include irradiating a first portion of the base component with the one or more laser beams having a first set of illumination properties to form a first pattern of the surface structures and irradiating a second portion of the base component with the one or more laser beams having a second set of illumination properties to form a second pattern of the surface structures.

In some embodiments, the first set of illumination properties may be selected to provide that the first pattern of surface structures has a first set of bonding properties, where the second set of illumination properties is selected to provide that the second pattern of surface structures has a second set of bonding properties.

In some embodiments, the first set of bonding properties and the second set of bonding properties may differ by at least one of shear strength, tensile strength, or torsion strength.

In some embodiments, a hybrid object is provided. The hybrid object may include a polymer component and a base component including surface structures that wick a polymer material in at least one of a molten state or a liquid state into cavities of the surface structures, where the polymer component is joined to the base component at an interface with the surface structures.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF FIGURES

The numerous advantages of the disclosure may be better understood by those skilled in the art by reference to the accompanying figures.

FIG. 1 illustrates a simplified diagram of a hybrid metal/polymer object, in accordance with one or more embodiments of the present disclosure.

FIG. 2A illustrates a flow diagram depicting steps performed in a method for bonding a solid polymer to a base component, in accordance with one or more embodiments of the present disclosure.

FIG. 2B illustrates a flow diagram depicting steps performed in a method for bonding a liquid polymer component to a base component, in accordance with one or more embodiments of the present disclosure.

FIG. 3A illustrates scanning electron microscope (SEM) images showing various surface structures formed on a surface, in accordance with one or more embodiments of the present disclosure.

FIG. 3B illustrates SEM images showing surface structures formed on a metal surface at different viewing angles, in accordance with one or more embodiments of the present disclosure.

FIG. 4A illustrates a cross-sectional view showing a fracture interface between a thermoplastic material bonded to processed aluminum, in accordance with one or more embodiments of the present disclosure.

FIG. 4B illustrates SEM images of a laser-processed metal surface showing mound-like microstructure patterns, in accordance with one or more embodiments of the present disclosure.

FIG. 5 illustrates a plot of stress versus displacement for a shear test, in accordance with one or more embodiments of the present disclosure.

FIG. 6 illustrates a plot of shear stress versus tensile strain for multiple samples of thin polymer material bonded to a processed surface, in accordance with one or more embodiments of the present disclosure.

FIG. 7 illustrates a graph showing shear stress versus tensile strain relationships for multiple samples, in accordance with one or more embodiments of the present disclosure.

FIGS. 8A and 8B illustrate graphs showing maximum stress versus length of processed area for different measurement orientations, in accordance with one or more embodiments of the present disclosure.

FIG. 9 illustrates a graph showing shear test comparison data for multiple samples, in accordance with one or more embodiments of the present disclosure.

FIGS. 10A, 10B, and 10C illustrate plots of tensile test results for three different samples, in accordance with one or more embodiments of the present disclosure.

FIG. 11 illustrates a plot of shear test comparison data showing stress versus strain for multiple samples, in accordance with one or more embodiments of the present disclosure.

FIG. 12 illustrates adhesion strength under shear loading versus strain percentage for angled surface structures, in accordance with one or more embodiments of the present disclosure.

FIG. 13 illustrates plastic deformation of angled surface structures after breaking, in accordance with one or more embodiments of the present disclosure.

FIG. 14 illustrates a plot of adhesion strength versus strain for different patterns of surface structures, in accordance with one or more embodiments of the present disclosure.

FIG. 15A illustrates a surface of a base component having two distinct patterns of surface structures, in accordance with one or more embodiments of the present disclosure.

FIG. 15B illustrates a checkerboard pattern of alternating surface structure regions arranged in a grid pattern, in accordance with one or more embodiments of the present disclosure.

FIG. 16A illustrates a block diagram of a system for bonding a polymer to a metal, in accordance with one or more embodiments of the present disclosure.

FIG. 16B illustrates a simplified schematic of a laser processing sub-system, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing direct bonding of a polymer material (or precursors of the polymer material) to another material (e.g., a base component) with a high adhesion strength (e.g., a high adhesion energy) by generating laser-induced surface structures designed to promote wicking of the polymer material into cavities of the surface structures. In this way, the polymer and the material of interest may have interlocking structures such that the resulting bond may have high adhesion strength under different conditions such as, but not limited to, shear conditions, tensile conditions, or other complex loading conditions. Further, the systems and methods disclosed herein may enable bonding to a wide range of materials (e.g., components) such as, but not limited to, metals, ceramics, dielectrics, or semiconductors.

In embodiments, a surface of a base component (e.g., a metal component, a ceramic component, a dielectric component, a semiconductor component, or the like) is irradiated with one or more laser pulses with parameters selected to generate surface structures designed to provide wicking, and in some cases superwicking, of a polymer component in a liquid state into cavities of surface structures in the base component, where the polymer component is formed from a polymer or a polymer precursor. Direct bonding may then be achieved through hardening of the polymer component.

For example, a surface of a polymer component including a solid polymer material may be melted to create a molten layer that may wick into cavities of surface structures on the second component, where a durable bond may be formed when the molten layer cools and hardens. This process may be suitable for creating strong bonds between a wide range of polymer and metal compounds without the need for additives to dissolve the polymer, high joining pressures, or complex pre/post processing steps. In particular, the fabrication surface structures that wick a molten polymer of interest may induce strong mechanical interactions between the base component and the polymer at even near-ambient joining pressures.

As another example, a polymer component including one or more polymer or polymer-forming materials may be placed on the first component and wicked into cavities of the surface structures, where a durable bond may be generated by curing the second element. Such a process may be suitable for, but not limited to, creating a bond between a thermoset and another base component.

As another example, a polymer component including one or more polymer or polymer-forming materials may be placed on the first component and wicked into cavities of the surface structures, where a durable bond may be generated by drying the second component. Such a process may be suitable for, but not limited to, bonding paints or other similar materials to other components.

Further, this process may be suitable for bonding polymers having low surface energies such as, but not limited to polyolefin or thermoplastics (e.g., polypropylene, or the like) to a wide range of materials for which polymer bonding is difficult or unachievable. For example, polyolefins are commonly used in many industries due to highly desirable properties and low cost, but are known to provide particularly poor adhesion to surfaces such as metals due to their low surface energies. However, the systems and methods disclosed herein provide direct bonding between polyolefins with metals with high adhesion strengths without the use of adhesives, solvents, mechanical fastening, or high pressures. As a result, the systems and methods disclosed herein are suitable for fabricating hybrid metal/polymer materials at nearly any stage in a manufacturing process in a scalable manner.

A surface of a base component may be illuminated with laser light having any parameters suitable for generating surface structures that provide wicking of the polymer of interest (or a liquid including polymer precursors). In some embodiments, a surface is illuminated with ultrashort pulses, which are considered herein to have pulse durations on the order of picoseconds, femtoseconds, or lower. For the purposes of illustration, various examples herein related to femtosecond laser surface processing (FLSP) techniques using pulses on the order of femtoseconds. However, this is merely illustrative and should not be interpreted as limiting the scope of the present disclosure. It is contemplated herein that FSLP may be used to generate self-organized features with dimensions on the order of micrometers to nanometers. In some cases, the self-organized features have multiple dimensional scales such as, but not limited to, micro-scale features covered with nano-scale features. It is further contemplated herein that surface structures may be tuned to provide wicking or even superwicking properties for nearly any polymer material including, but not limited to, polymers with low surface energies that provide weak bonds or no bonds using existing techniques.

The surface structures generated through laser processing may be tailored to provide specific bonding characteristics that optimize adhesion performance for particular applications and loading conditions. The morphology, dimensions, and spatial arrangement of these structures may be controlled through precise selection of laser parameters, enabling the creation of bonding interfaces with customized mechanical properties. This level of control allows for the development of hybrid polymer-metal objects that exhibit enhanced performance under specific stress conditions while maintaining the beneficial properties of both constituent materials.

The orientation of surface structures relative to the base component surface may significantly influence the directional bonding properties of the resulting interface. By adjusting the angle of laser incidence during processing, surface structures may be formed with specific angular orientations that provide asymmetric mechanical interlocking between the polymer and base components. This directional control enables the creation of bonding interfaces that exhibit different adhesion strengths depending on the direction of applied mechanical loading, allowing for optimization of bond performance for applications where forces are anticipated to act primarily in known directions.

Beyond individual structure characteristics, the spatial distribution and patterning of surface structures across the bonding interface may provide additional opportunities for tailoring adhesion properties. Surface structures may be arranged in specific geometric patterns or distributed in predetermined regions to create bonding interfaces with spatially varying mechanical properties. Furthermore, complex bonding interfaces may incorporate multiple types of surface structures with different bonding characteristics within the same interface, enabling the creation of hybrid bonding zones where different regions are optimized for different types of mechanical loading conditions such as shear, tensile, torsional forces, or any combination thereof.

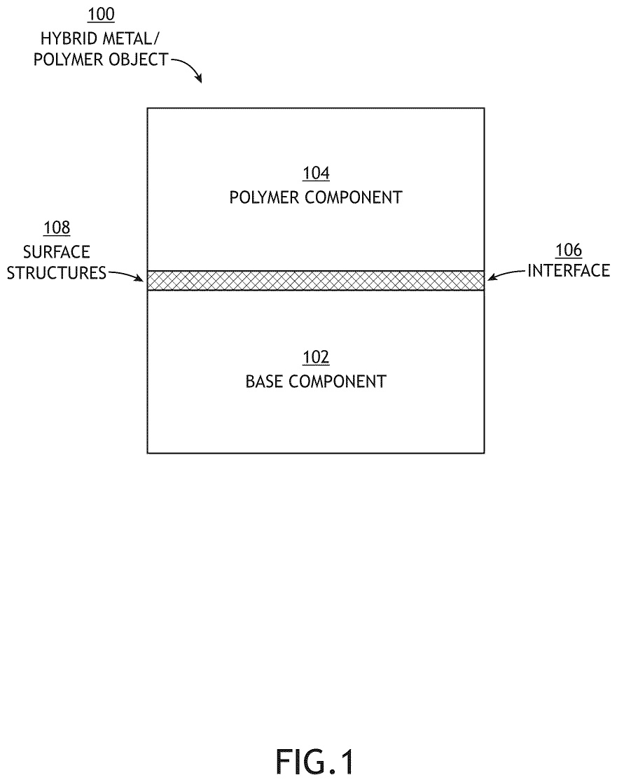

Referring now to FIGS. 1-16B, systems and methods providing direct bonding of polymer with metal are described, in accordance with one or more embodiments of the present disclosure.

FIG. 1 illustrates a simplified diagram of a hybrid metal/polymer object 100, in accordance with one or more embodiments of the present disclosure.

In embodiments, a hybrid metal/polymer object 100 is formed from a base component 102 joined with a polymer component 104 (e.g., a polymer component) at an interface 106. Further, a surface of the base component 102 at the interface 106 may include surface structures 108 designed to wick the polymer component 104 when in a liquid state. In this way, the liquid-state polymer component 104 may be distributed into cavities of the surface structures 108 at the interface 106 to form a direct bond between the base component 102 and the polymer component 104 when the polymer component 104 hardens (e.g., cools, cures, dries, or the like).

The polymer component 104 may have any composition suitable for wicking into surface structures 108 of a base component 102 of interest. For example, the polymer component 104 may be formed from, but is not limited to, a polyolefin, a thermoplastic (e.g., polypropylene, or the like), a thermoset, a paint, or an epoxy. Further, the polymer component 104 may include a polymer or a polymer precursor.

The base component 102 may have any composition suitable for providing surface structures 108 that wick a polymer component 104 of interest. For example, the base component 102 may be formed from a metal such as, but not limited to, aluminum, nickel, copper, steel, or alloys thereof. As another example, the base component 102 may be formed from a ceramic. As another example, the base component 102 may be formed from a dielectric. As another example, the base component 102 may be formed from a semiconductor.

The surface structures 108 may have any composition formed in response to illumination with one or more laser beams. In some embodiments, at least a portion of the surface structures 108 have the same composition as the bulk of the base component 102. In some embodiments, at least a portion of the surface structures 108 are formed from an oxide of the composition of the bulk of the base component 102.

The surface structures 108 may have any dimensions or combinations of dimensions suitable for wicking a liquid polymer of interest. For example, the surface structures 108 may include features on the order of micrometers, nanometers, or a combination thereof. As non-limiting illustrations, the surface structures 108 may have features with dimensions equal to or less than 1000 micrometers, 100 micrometers, 10 micrometers, 1000 nanometers, 100 nanometers, 10 nanometers, or smaller. In some cases, the surface structures 108 have multi-scale features such as, but not limited to, micro-scale features covered with nano-scale features.

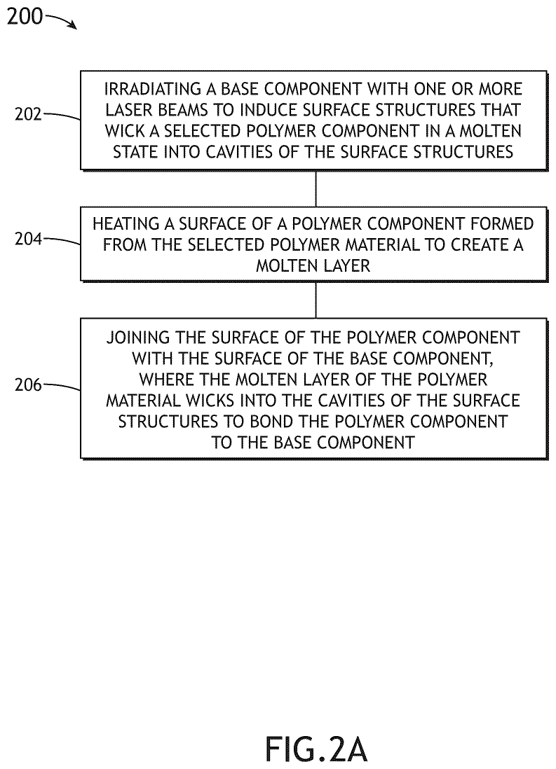

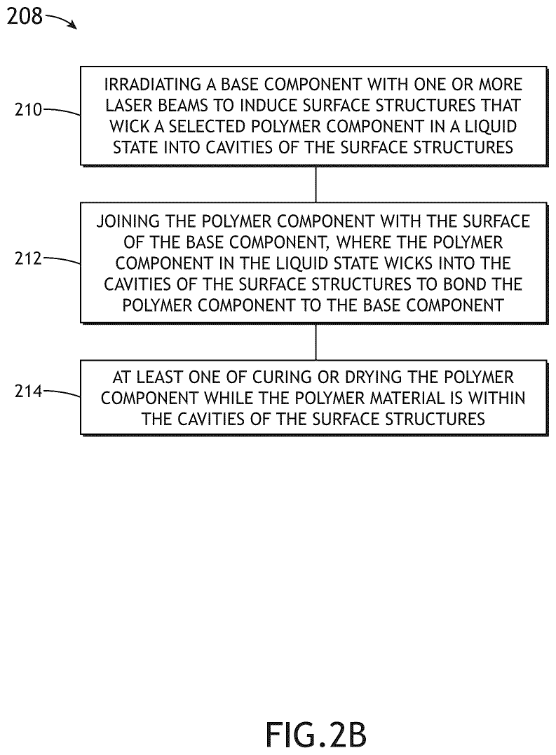

FIG. 2A illustrates a flow diagram depicting steps performed in a method 200 for bonding a solid polymer to a base component 102, in accordance with one or more embodiments of the present disclosure.

The method 200 may include a step 202 of irradiating a base component 102 with one or more laser beams to induce surface structures 108 on a surface of the base component 102 that wick a selected polymer component 104 in a molten state into cavities of the surface structures 108. For example, properties of the laser beams such as, but not limited to, pulse duration, repetition rate, wavelength, intensity, fluence, or dose may be selected to induce surface structures 108 that wick the material forming the polymer component 104.

The formation of some types of surface structures 108 using laser illumination, particularly laser illumination with ultrashort pulses, is generally described in Zuhlke, C. A., et al. (2013), “Formation of multiscale surface structures on nickel via above surface growth and below surface growth mechanisms using femtosecond laser pulses,” Optics Express, 21 (7), 8460-8473; Zuhlke, C. A., et al. (2013), “Fundamentals of layered nanoparticle covered pyramidal structures formed on nickel during femtosecond laser surface interactions,” Applied Surface Science, 21 (7), 8460-8473; Anderson, M., et al. (2021), “Surface and microstructure investigation of picosecond versus femtosecond laser pulse processed copper,” Surface and Coatings Technology, 409, 126872; Anderson, M., et al. (2023), “Formation mechanism of micro/nanoscale structures on picosecond laser pulse processed copper,” Materials Today Advances, 19; Tsubaki, A. T., et al. (2017), “Formation of aggregated nanoparticle spheres through femtosecond laser surface processing,” Applied Surface Science, 419, 778-787; and Peng, E., et al. (2017), “Growth mechanisms of multiscale, mound-like surface structures on titanium by femtosecond laser processing,” Journal of Applied Physics, 122 (13), 133108; all of which are incorporated herein by reference in their entireties.

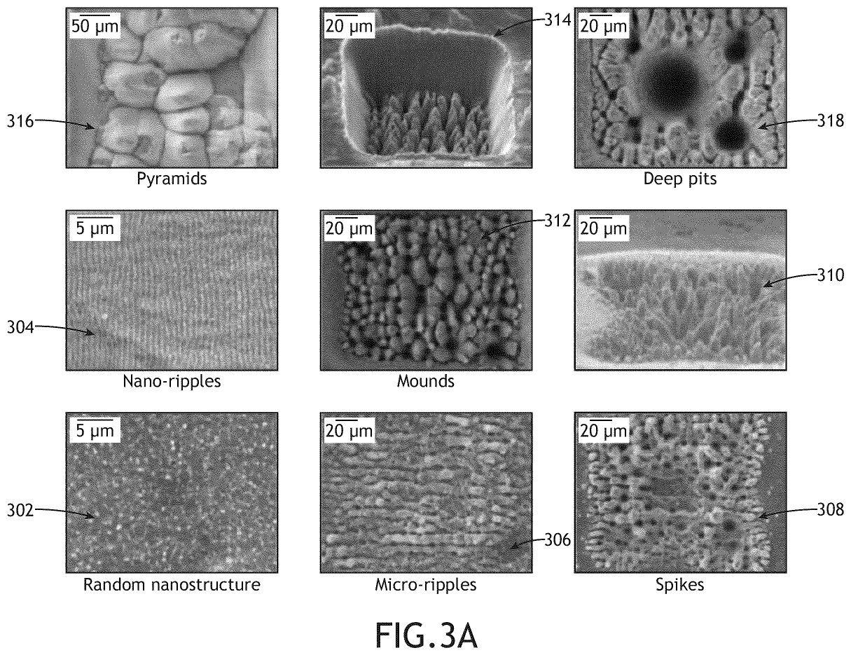

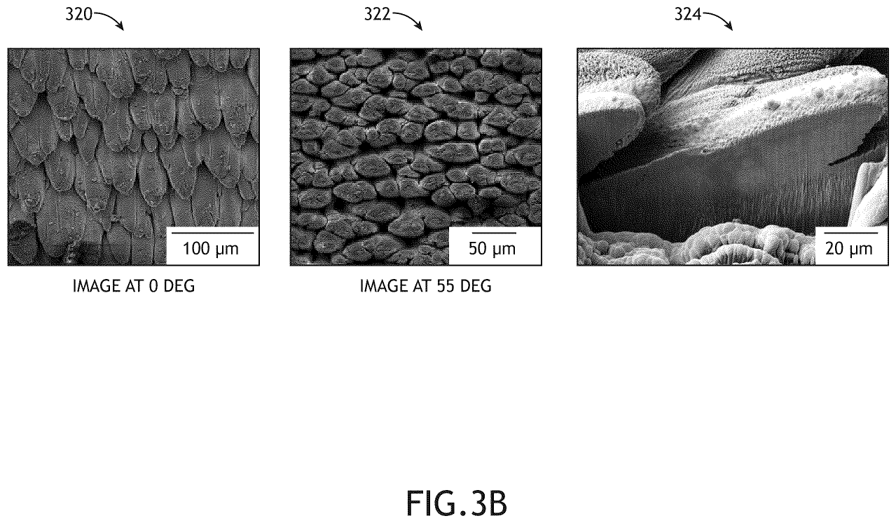

FIG. 3A illustrates scanning electron microscope (SEM) images of various surface structures 108 formed in nickel (e.g., a metal base component 102) using different combinations of parameters of a femtosecond laser beam, in accordance with one or more embodiments of the present disclosure. In particular, the various surface structures 108 in FIG. 3A are generated by scanning a base component 102 with respect to a focused femtosecond laser beam (e.g., a laser beam including laser pulses with pulse durations on the order of femtoseconds), where the properties of the fabricated surface structures 108 are controlled through selection of the intensity, fluence, and dose.

In FIG. 3A, images 302-304 depict surface structures 108 with a primary dimensional scale on the order of nanometers. In particular, image 302 depicts self-organized nanostructures with a random distribution across the surface, whereas image 304 depicts a periodic or quasi-periodic pattern of nano-scale features, which may be referred to as nano-ripples or laser-induced periodic surface structures (LIPSS). Image 306 depicts surface structures 108 with a primary dimensional scale on the order of micrometers. In particular, image 306 depicts a periodic or quasi-periodic pattern of micro-scale features, which may be referred to as micro-ripples.

Images 308-314 depict self-organized multi-scale surface structures 108 having features with both micro-scale and nano-scale features. Images 308-310 depicts multi-scale features that protrude from an original surface height, which may be referred to as spikes. Such surface structures 108 may be characterized by melting and resolidification of the surface into the spike structures and may further include a layer of nanoparticles formed at least in part by redeposition of ablated material. Images 312-314 depict multi-scale features referred to herein as mounds that lie primarily below the original surface and are characterized by more significant ablation of material from the surface, but also include self-organized micro-scale features covered by nanoparticles.

Image 316 depicts multiscale surface structures 108 referred to herein as pyramids formed through preferential ablation of material to form micro-scale features and deposition of a relatively thick layer of nanoparticles from redeposition of ablated material.

Image 318 depicts surface structures 108 including the formation of micro-scale pits, which may be surrounded by other features such as the mounds or spike surface structures 108.

The various surface structures 108 depicted in FIG. 3A are merely illustrative of possible types of features that may be suitable for wicking a polymer component 104 of interest for the formation of a hybrid metal/polymer object 100 as disclosed herein and should not be interpreted as limiting the scope of the present disclosure. Broadly, the step 202 may utilize any laser processing technique for generating surface structures 108 on a surface of a base component 102 that wicks a molten polymer of interest.

In some embodiments, at least some of the surface structures 108 are angled with respect to a normal of the surface of the base component 102. For example, the step 202 may include irradiating the base component 102 with one or more pulsed laser beams at a selected non-normal incidence angle and a selected azimuth direction, where at least some of the surface structures 108 are oriented in a direction of the non-normal incidence angle.

FIG. 3B illustrates SEM images of angled structures, in accordance with one or more embodiments of the present disclosure. In particular, FIG. 3B depicts surface structures 108 fabricated with illumination incident on a stainless steel sample at an angle of 55 degrees, where a peak fluence of incident laser pulses was set to 3.25 J/cm\hat{ }2 and a pulse count per area was 5755. Image 320 depicts the angled surface structures 108, where the image was captured at 0 degrees (e.g., normal to a surface of the sample). Image 322 depicts the angled surface structures 108, where the image was captured at 55 degrees relative to the surface normal. Image 324 depicts a cross-section of one of the microscale surface structures captured from an oblique angle. As shown in images 320-324, the surface structures 108 do not extend upward normal to the surface but instead extend at 55 degree angle, which matches the angle of incidence of the laser pulses.

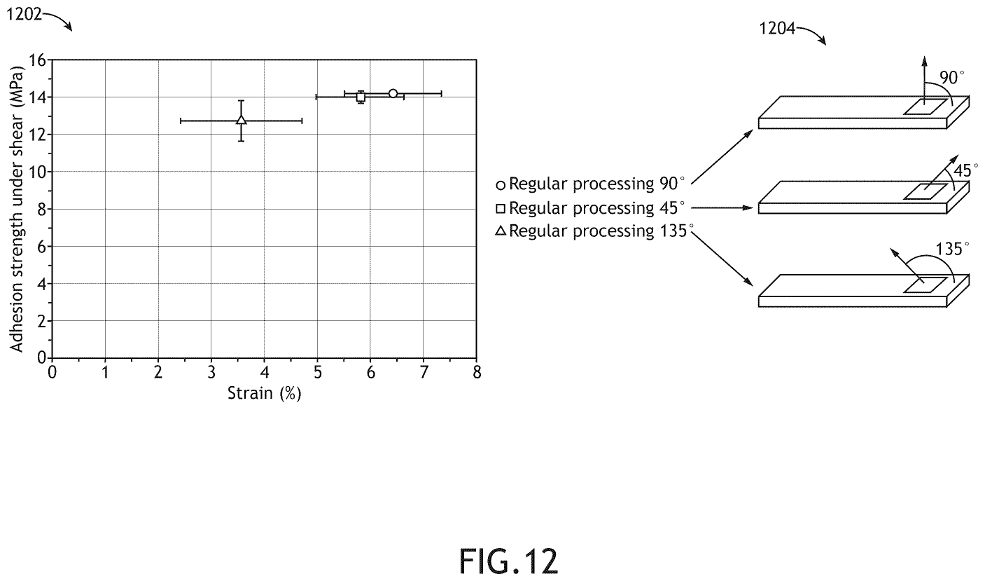

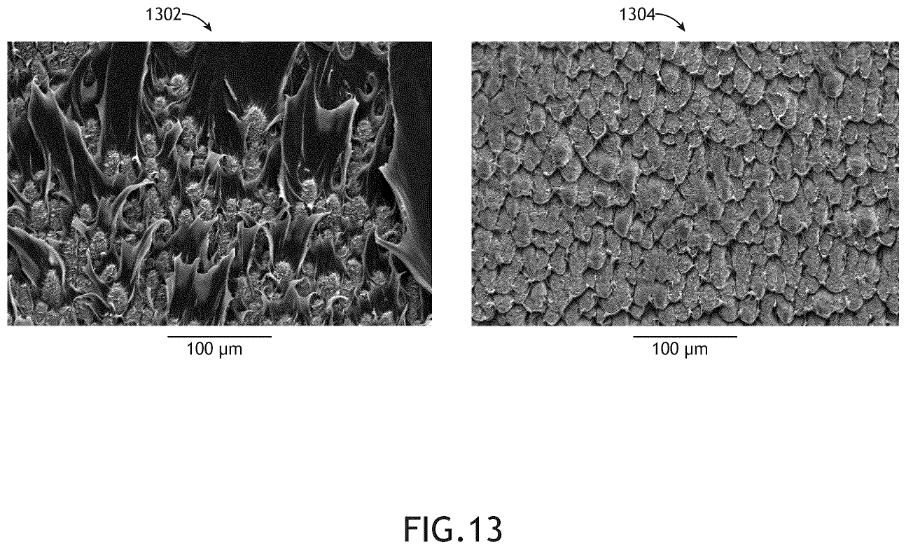

It is contemplated herein that angled surface structures 108 may provide directional adhesion properties and in some cases increased adhesion strength in various types of loading configurations. For example, angled surface structures 108 may provide increased shear strength along a direction opposed to the surface structures 108 relative to other directions. As another example, angled surface structures 108 may in some cases provide increased tensile strength than surface structures 108 oriented normal to the surface of the base component 102 since the polymer component 104 may wrap around the microscale surface structures 108 and provide bonding to undersides of the microscale surface structures 108. More generally, angled surface structures 108 may provide increased adhesion strength in a wide range of complex loading conditions. The bonding performance of angled surface structures 108 is described in greater detail with respect to FIGS. 12-13 below.

Referring again to FIG. 2A, the method 200 may include a step 204 of heating a surface of a solid polymer component 104 formed from the selected polymer material to create a molten layer and a step 206 of joining the surface of the polymer component 104 with the surface of the polymer component 104, where the molten layer of the polymer material wicks into the cavities of the surface structures 108 of the base component 102 to bond the polymer component 104 to the base component 102.

The step 204 of heating a surface of the polymer component 104 may be performed in various ways. For example, the surface of the polymer component 104 may be heated prior to joining with the base component 102 in step 206 using any heat source such as, but limited to, a hot plate, an oven, a flame, a hot gun, or infrared radiation. As another example, the surface of the polymer component 104 may be heated after contact is made with the base component 102 in step 206. For instance, the base component 102 may be heated using any heat source in such a way that heat is transferred to the surface of the polymer component 104 to melt the surface of the polymer component 104 and induce wicking of the polymer material into the surface structures 108.

The step 206 may further be performed in various ways. In a general sense, it is contemplated herein that designing surface structures 108 on the base component 102 that induce wicking of polymer into surface structures 108 may beneficially reduce a pressure necessary to provide contact between the base component 102 and the polymer component 104. In some cases, a strong bond may be formed using near ambient pressures or pressures achievable by a user pressing the polymer component 104 to the surface by hand. In some cases, a strong bond may be formed using a static pressure in a range of 0.01-2 bars, though this is merely an illustration and not limiting on the scope of the present disclosure. It is contemplated herein that alternative techniques such as hot press molding or injection molding typically utilize substantially higher pressures on the order of 20-1000 bars. As a result, the systems and methods disclosed herein may provide benefits over alternative techniques that require substantial pressure to force contact between polymer and metal surfaces and melting of the entirety of a polymer piece. In particular, the systems and methods disclosed herein may allow a polymer component 104 to retain its shape before and after joining with the base component 102.

FIG. 2B illustrates a flow diagram depicting steps performed in a method 208 for bonding a liquid polymer component 104 to a base component 102, in accordance with one or more embodiments of the present disclosure. For example, the liquid polymer component 104 may include polymer molecules, polymer-forming materials, polymer precursors, or any other suitable material that may ultimately form a polymer.

The method 208 may include a step 210 of irradiating a base component 102 with one or more laser beams to induce surface structures 108 on a surface of the base component 102 that wick a selected polymer component 104 in a liquid state into cavities of the surface structures 108. The step 210 may be similar or equivalent to the step 202 such that the description of step 202 may apply to the step 210.

The method 208 may include a step 212 of joining the polymer component 104 with the surface of the base component 102, where the polymer component 104 in the liquid state wicks into the cavities of the surface structures 108 of the base component 102 to bond the polymer component 104 to the base component 102. The step 212 may be similar or equivalent to the step 206 such that the description of step 206 may apply to the step 212, except that the entirety of the polymer component 104 in step 212 may be in a liquid state. For instance, the method 208 may be suitable for, but is not limited to, polymer-forming materials and/or polymer precursor materials that harden upon an additional process such as, curing or drying. As an illustration, the step 212 may utilize precursor materials of a thermoset material, a paint, an epoxy, or the like.

The method 208 may include a step 214 of at least one of curing or drying the polymer component 104 while the polymer material is within the cavities of the surface structures. The step 214 may incorporate any type of curing or drying process such as, but not limited to, exposing the polymer component 104 to heat, electromagnetic radiation (e.g., light), pressure, or a catalyst.

Referring again generally to FIGS. 2A-2B, various additional aspects of methods for fabricating a hybrid metal/polymer object 100 are described.

In some embodiments, a step of irradiating a base component 102 to fabricate surface structures that work a selected polymer component in a molten and/or liquid state (e.g., step 202 shown in FIG. 2A, step 210 shown in FIG. 2B, or the like) may include selecting a design of surface structures 108 (and the laser parameters to fabricate this selected design) that provides selected wicking behavior during a joining step of the selected polymer component under selected conditions (e.g., during a step 206 shown in FIG. 2A, step 212 shown in FIG. 2B, or the like).

For example, the laser parameters may be selected to generate surface structures 108 with specific wicking properties tailored to the polymer component 104 and processing conditions of interest. In some cases, the surface structures 108 may be designed to provide wicking of a selected polymer composition under a selected pressure range by controlling the surface energy, roughness, and geometric characteristics of the fabricated features. The wicking behavior may be influenced by the contact angle between the molten polymer and the surface structures 108, which in turn depends on the surface energy of the structured surface and the surface tension of the polymer. By adjusting laser parameters such as fluence, pulse count, and scanning speed, the morphology and surface chemistry of the surface structures 108 may be tuned to achieve desired wicking properties that promote polymer infiltration into the cavities at specific operating pressures used during bonding.

The ability to tailor surface structures 108 for specific wicking conditions may be particularly advantageous for low-pressure bonding applications. For instance, surface structures 108 with high surface area and appropriate pore sizes may be fabricated to enable wicking of a particular composition of a polymer component at pressures such as, but not limited to pressures in a range of 0.01-2 bars.

In some embodiments, the surface structures 108 may be designed to exhibit superwicking behavior for a selected composition of a polymer component 104, where the polymer component 104 spontaneously infiltrates the cavities without applied pressure due to favorable capillary forces. This capability may enable bonding processes that require minimal or no external pressure, reducing equipment complexity and enabling bonding of delicate or thin polymer components 104 that might be damaged under higher pressures.

Additionally, the surface structures 108 may be designed to provide selective wicking properties based on properties such as, but not limited to, processing temperature or polymer viscosity. For example, surface structures 108 with smaller feature sizes may be suitable for wicking low-viscosity polymer melts, while larger cavities may be designed for higher viscosity materials or applications where rapid infiltration is desired. The laser processing parameters may also be selected to create surface structures 108 with specific surface chemistries, such as controlled oxidation levels, that further enhance the wetting behavior of particular polymer compositions. This level of control may allow for optimization of the bonding process for specific polymer-base component combinations and processing conditions.

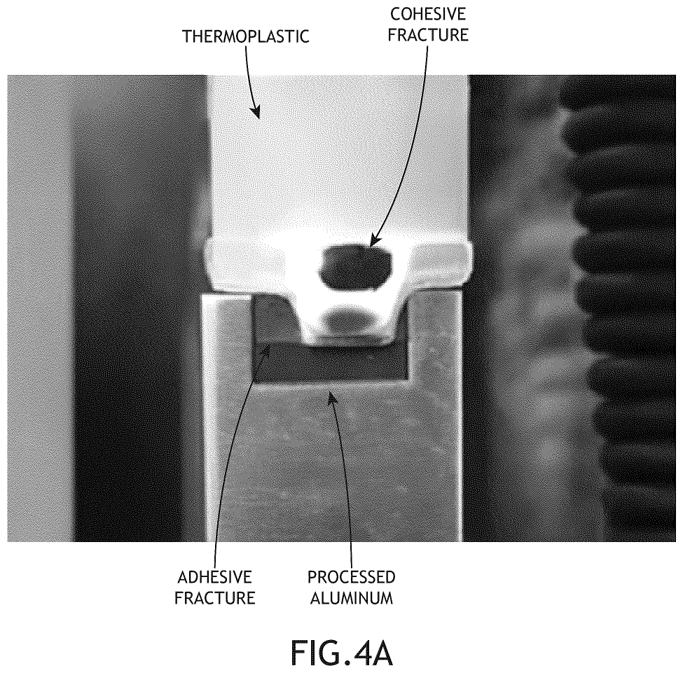

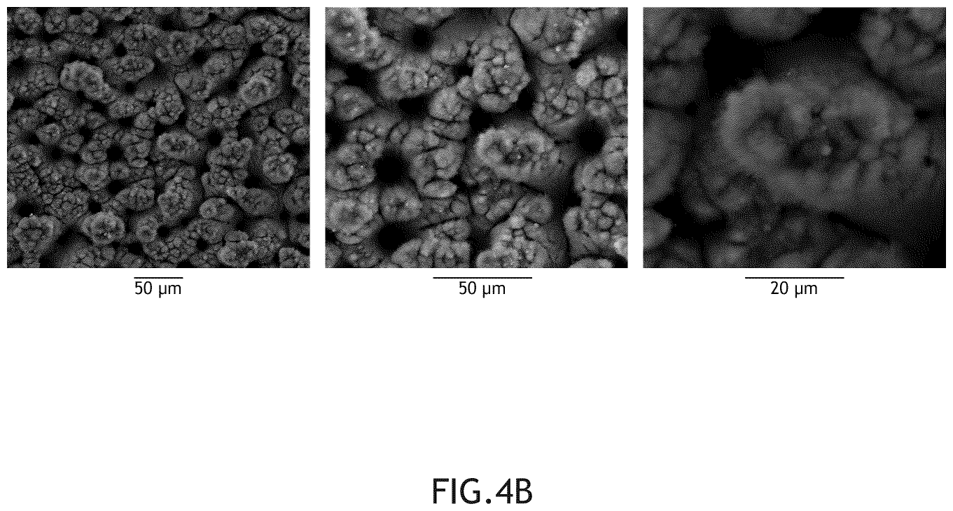

FIGS. 4A-9 illustrate experimental demonstrations of bonding metal to polymer, in accordance with one or more embodiments of the present disclosure.

FIG. 4A illustrates an image of a hybrid metal/polymer object 100 including an aluminum base component 102 and polypropylene (e.g., a low-energy thermoplastic) polymer component 104 after a shear fracture test, in accordance with one or more embodiments of the present disclosure. The surface structures 108 of the hybrid metal/polymer object 100 in FIG. 4A are formed using FLSP techniques. FIG. 4A further shows both adhesive fracture and cohesive fracture of the polymer component 104 during the shear fracture test.

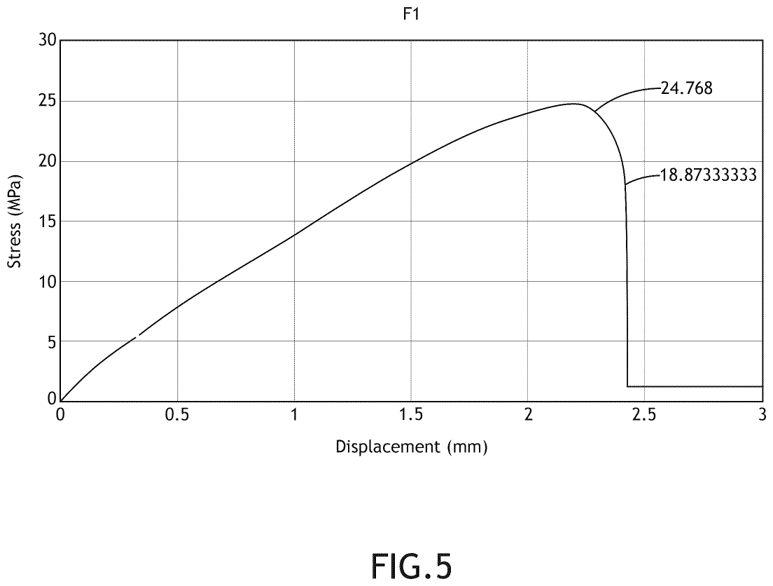

FIG. 4B illustrates SEM images, at different magnifications, of the type of FLSP surface structures 108 that are on the surface of the processed aluminum in FIG. 4A and used to obtain the results illustrated in FIGS. 5-9, in accordance with one or more embodiments of the present disclosure. The SEM images show the multi-scale surface features that are mound-like on the micro-scale and are overlaid with a porous nano-particle layer. There are pits with diameter around 10 μm in the valleys between the micro-structures. The nano-porous layer is visible as a fuzzy surface in the highest-magnification image. The features were produced using a femtosecond laser that produces 35 fs pulses, at a 1 kHz repetition rate, with a central wavelength of 800 nm, and with a Gaussian spatial profile. The features were produced using a peak fluence of 2.65 J/cm² and a pulse count of 490. Pulse count is defined as the number of times each location on the sample is hit with a laser pulse during raster scanning of the surface. The spot size (diameter) of the laser on the sample surface was 500 μm. The FLSP surface has an average peak-to-valley structure height of 138.6 μm and am average roughness of 11.54 μm, measured using a laser scanning confocal microscope.

FIGS. 5-9 illustrate plots of adhesion under shear conditions for variations of a hybrid metal/polymer object 100 formed from an aluminum base component 102 and polypropylene polymer component 104. It is noted that polypropylene does not provide any bond (e.g., 0 MPa) with aluminum in the absence of surface structures 108 formed in accordance with the present disclosure.

FIG. 5 illustrates a plot of shear stress as a function of displacement for a hybrid metal/polymer object 100 with an aluminum base component 102 and polypropylene polymer component 104, in accordance with one or more embodiments of the present disclosure. In this experimental demonstration, the hybrid metal/polymer object 100 provided an adhesion strength of over 24 MPa under shear conditions. It is noted that this value of 24 MPa shear adhesion strength is substantially higher than existing bonding techniques for even high-energy polymers (e.g., polymers that are easier to bond with metals such as ABS, PMMA, PBT, or the like) and/or techniques involving substantial pre-processing or pressures during a bonding step.

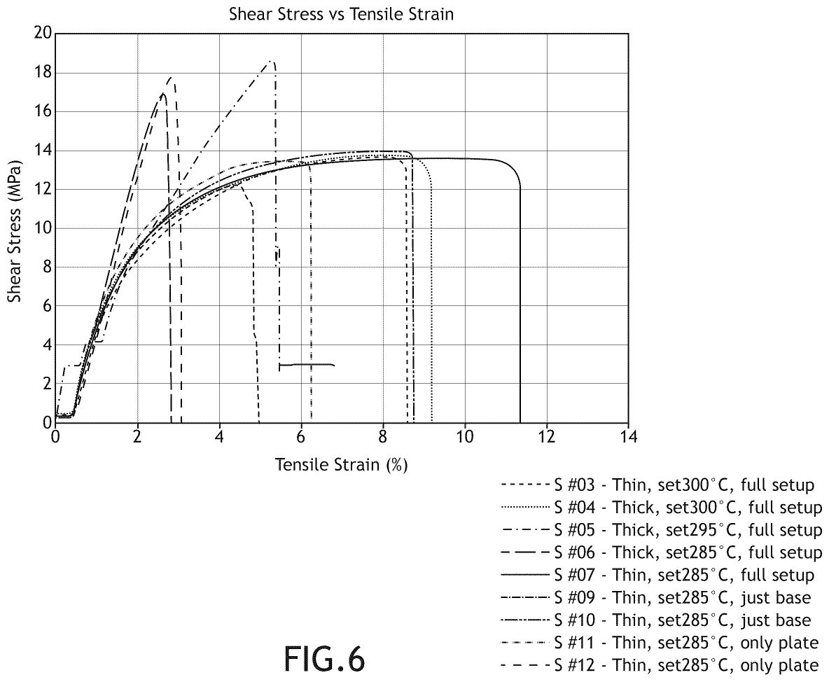

FIG. 6 illustrates a plot of shear stress as a function of tensile strain for a hybrid metal/polymer object 100 with an aluminum base component 102 and polypropylene polymer component 104, in accordance with one or more embodiments of the present disclosure. In this experimental demonstration, the impact of various parameters was explored including different thicknesses of the polymer component 104 (thick=6 mm, thin=2.3 mm), different set temperatures (e.g., heating temperatures in step 204 of the method 200), different heating technique in step 204 (“just base” refers to the use of just a heating plate, “only plate” refers to the use of a heating plate and an aluminum base, and “full setup” refers to the use of and a heating plate, an aluminum base, and a frame to align the base and polymer components during joining). FIG. 6 illustrates that increasing the thickness of the polymer component 104 generally increases the adhesion strength.

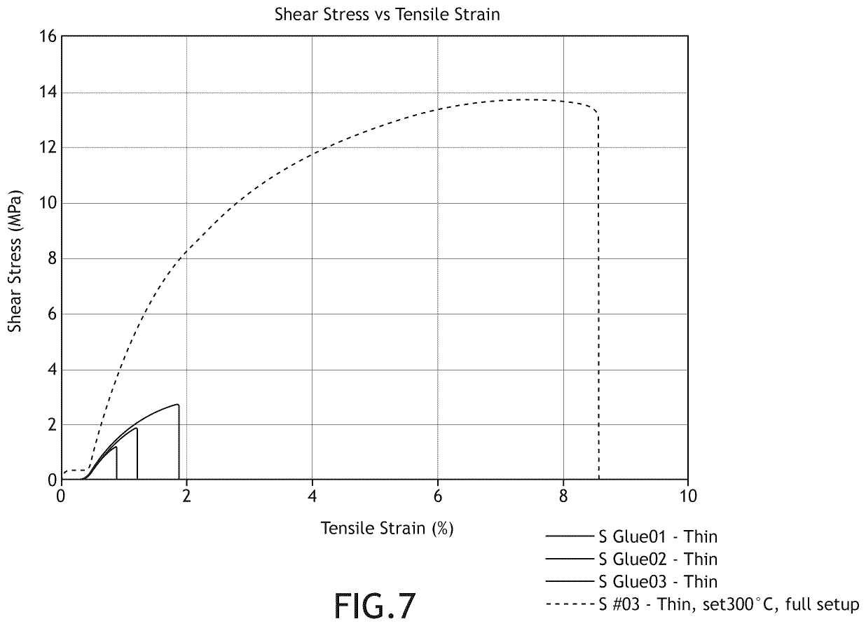

FIG. 7 illustrates a plot of shear adhesion strengths for a hybrid metal/polymer object 100 with an aluminum base component 102 and polypropylene polymer component 104 compared to shear adhesion strengths associated with a bond formed with a glue, in accordance with one or more embodiments of the present disclosure. In particular, the experimental demonstrations in FIG. 7 compared sample #03 from FIG. 6 to samples utilizing a cyanoacrylate glue (e.g., Loctite 422) to form a bond between polypropylene and unprocessed aluminum (e.g., aluminum without surface structures 108), where the different graphs are associated with multiple tests with slight variations in glue layer thickness. FIG. 7 demonstrates that the hybrid metal/polymer object 100 exhibits a substantial performance improvement over any of the glued samples.

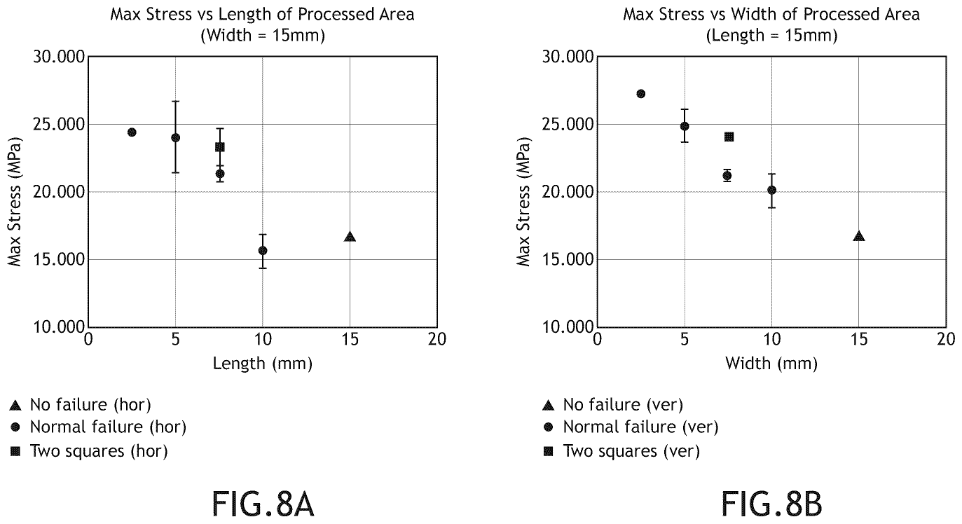

FIGS. 8A-8B illustrate plots of shear adhesion strengths for a hybrid metal/polymer object 100 with an aluminum base component 102 and polypropylene polymer component 104 for varying widths and lengths of a region of surface structures 108 bonded to the polymer component 104, in accordance with one or more embodiments of the present disclosure. The overall shape of the processed area affects the adhesion performance. The width refers to the dimension of the processed area which is perpendicular to the loading direction, while the length represents the dimension of the processed area that is parallel to the loading direction. FIG. 8A shows data for horizontal rectangles (where the longer side is horizontal and perpendicular to the vertical loading direction), while FIG. 8B shows data for vertical rectangles (where the longer side is vertical and parallel to the loading direction). The “two squares” data points represent a single processed area consisting of two squares separated by a small unprocessed area—in FIG. 8A the two squares are placed side by side, while in FIG. 8B the two squares are stacked vertically one above the other. It is contemplated herein that the adhesion strength may vary locally across a bonded area and that a measured adhesion strength may be impacted by the size and orientation of a region of surface structures 108 in a bonding region. In this set of experimental demonstrations, the shear strength ranged from 15 MPa to over 27 MPa and generally decreased as the size of the region of surface structures 108 increased. As a result, global adhesion strength may be tailored by fabricating patterns of different types of surface structures 108 across a bonding region.

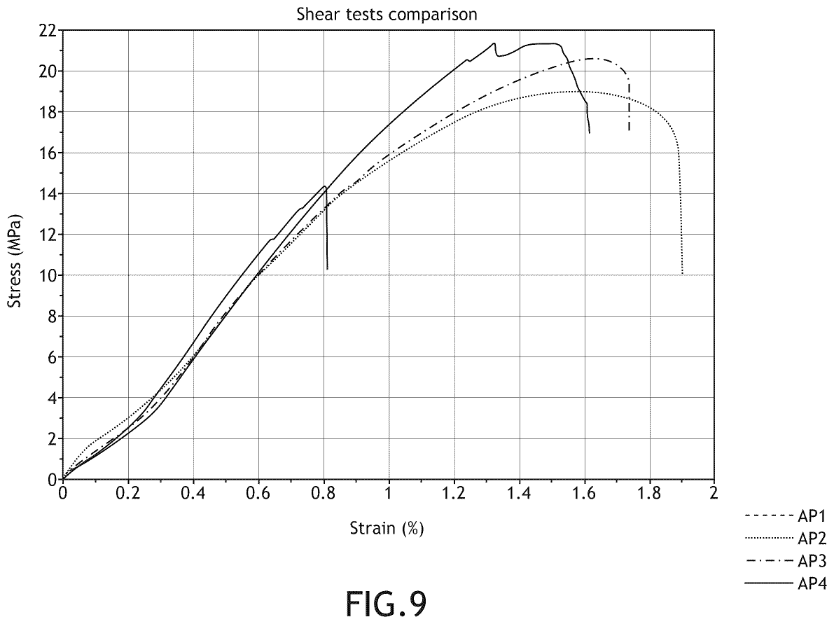

FIG. 9 illustrates a plot of shear adhesion strength tests for a hybrid metal/polymer object 100 with an aluminum base component 102 and an ABS (e.g., a thermoplastic) polymer component 104, in accordance with one or more embodiments of the present disclosure. In FIG. 9, multiple samples (AP1-AP4) were tested which resulted in adhesion shear strengths between 19-21 MPa.

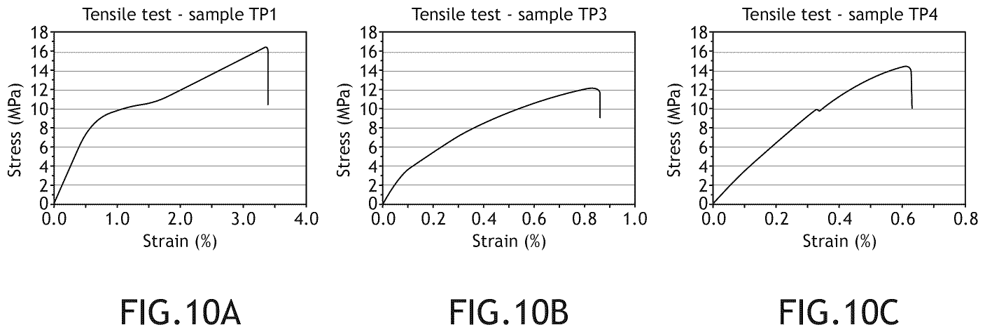

FIGS. 10A-10C illustrate plots of adhesion under tensile loading for three samples of a hybrid metal/polymer object 100 with an aluminum base component 102 and polypropylene polymer component 104, in accordance with one or more embodiments of the present disclosure. In FIGS. 10A-10C, the tensile adhesion strengths are between 12-16 MPa. Again, since polypropylene does not bond to an unstructured aluminum surface, data for unstructured surfaces is not available (e.g., is 0 MPa).

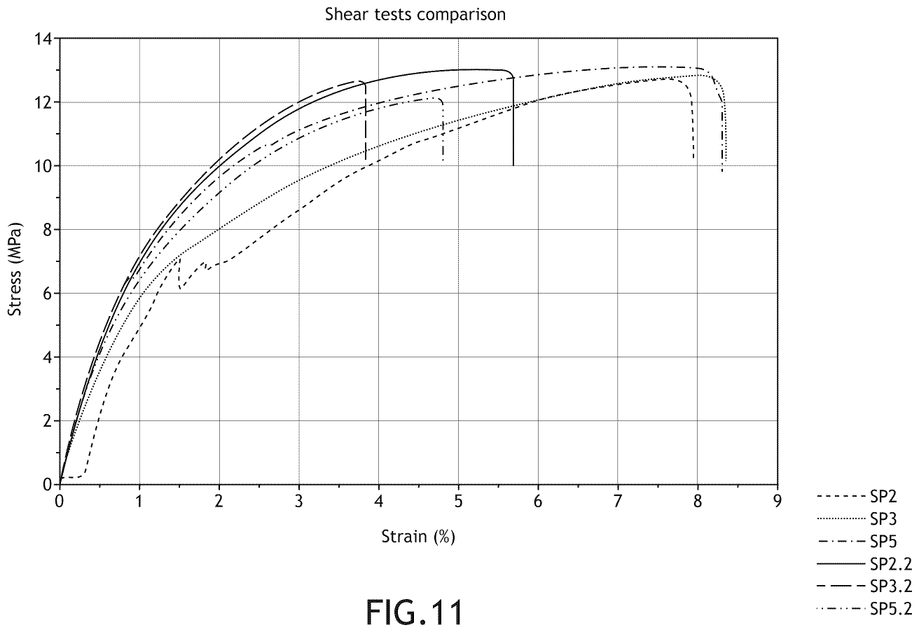

Referring now to FIG. 11, experimental demonstrations of repairability of a bond between metal and polymer based on wicking into surface structures 108 is described. FIG. 11 illustrates a plot of shear adhesion strengths for a hybrid metal/polymer object 100 with an aluminum base component 102 and polypropylene polymer component 104 for both a first bond and a second bond after destruction of the first bond, in accordance with one or more embodiments of the present disclosure. In FIG. 11, datalines SP2, SP3, and SP4 represent shear adhesion strengths for a first bond on three samples. After failure, the method 200 was repeated to form a second bond between the same materials on each sample. Datalines SP2.2, SP3.2, and SP4.2 represent shear adhesion strengths for this second, repaired bond on the three samples. In all cases (original or repaired), the adhesion strength is between 12 and 13 MPa for these tests, which demonstrates repairability of the bond. In cases where portions of the polymer component 104 remain after the first failure, new material associated with an additional application of the polymer component 104 may diffuse and/or become entangled with the remaining polymer material.

Referring now to FIGS. 12-13, experimental demonstrations of bonding between a metal with angled surface structures 108 and a polymer component 104 are described. As described with respect to FIG. 3B, when the base component 102 is irradiated with one or more laser beams at a non-normal incidence angle and a selected azimuth direction, at least some of the surface structures 108 are oriented in a direction of the non-normal incidence angle. This directional orientation of the surface structures 108 creates asymmetric mechanical interlocking between the polymer component 104 and the base component 102, where the resistance to mechanical loading varies depending on the direction of applied force relative to the angle of the surface structures 108. In some embodiments, the angled surface structures 108 may be specifically designed with interlocking geometries that counteract mechanical stresses under specific loading directions including shear, tensile, torsion and/or complex loadings.

FIG. 12 illustrates a plot 1202 showing adhesion strength under shear loading versus strain percentage at fracture (or joint failure) for angled surface structures 108, in accordance with one or more embodiments of the present disclosure. The plot 1202 includes data points for regular processing at normal incidence angle (90° relative to the surface), angled processing at 45°, and angled processing at 135° (e.g., 45 degrees from normal in an opposite direction). An inset 1204 illustrates three schematic diagrams showing the different processing angle configurations at 90°, 45°, and 135° relative to the surface. In this experimental demonstration of shear testing, the polymer component 104 was pulled in the same direction as the 45 degree angle surface structures 108, while the polymer component 104 was pulled in the opposite direction as the 135 degree angle surface structures 108. As illustrated in the plot 1202, the strain at break was highest for surface structures 108 fabricated at a normal incidence angle (90 degrees from surface). The strain at break reduced slightly for the 45 degree surface structures 108 and was significantly lower for the 135 degree surface structures 108. Lower strain at break values correlate to less plastic deformation of the polymer component 104 during testing. It is noted that the adhesion performance may be highly dependent on factors such as, but not limited to, material compositions of the base component 102 and the polymer component 104, specific types of surface structures 108 fabricated, or specific angles of the surface structures 108. Although the lowest strain at break was observed when pulling the polymer against the angled structures (here, the 135 degree case) in this particular experiment, it is to be understood that this particular experiment may not be indicative of all cases and that the results are merely illustrative and not limiting on the scope of the present disclosure. In some cases, adhesion performance may increase when the polymer component 104 is pulled against angled surface structures 108.

FIG. 13 illustrates plastic deformation of the angled surface structures 108 tested in FIG. 12 after breaking, in accordance with one or more embodiments of the present disclosure. An image 1302 depicts a SEM image of the surface structures 108 angled at 45 degrees tested in the plot 1202. The image 1302 shows substantial plastic deformation upon break. An image 1304 depicts a SEM image of the surface structures 108 angled at 135 degrees tested in the plot 1202. The image 1304 shows substantially less plastic deformation upon break than the image 1302. This difference in plastic deformation behavior between the two angled configurations demonstrates how the orientation of the surface structures 108 affects the mechanical response of the hybrid polymer object 100 under loading conditions.

Referring generally to FIGS. 12-13, it is contemplated herein that directional properties of angled surface structures 108 may provide tailored adhesion characteristics for specific applications where loading occurs primarily in known directions. The ability to control deformation behavior through surface structure orientation may be advantageous for different applications with varying performance requirements. For instance, applications requiring high energy absorption during failure may benefit from surface structures 108 that promote substantial plastic deformation, while applications where brittle failure is preferred to prevent gradual degradation may benefit from surface structures 108 that exhibit minimal deformation before break. More generally, the ability to control the orientation of surface structures 108 through selection of laser incidence angle and azimuth direction enables the fabrication of bonding interfaces with directionally-dependent mechanical properties that may be optimized for specific loading scenarios encountered in various applications.

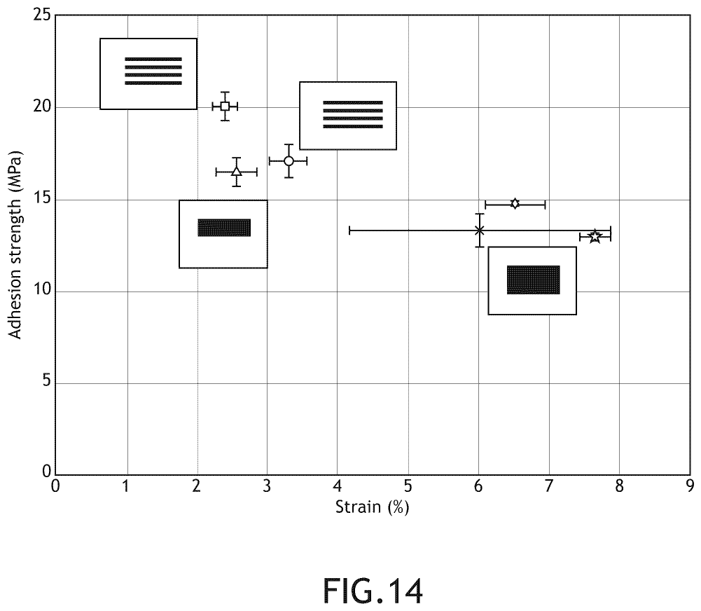

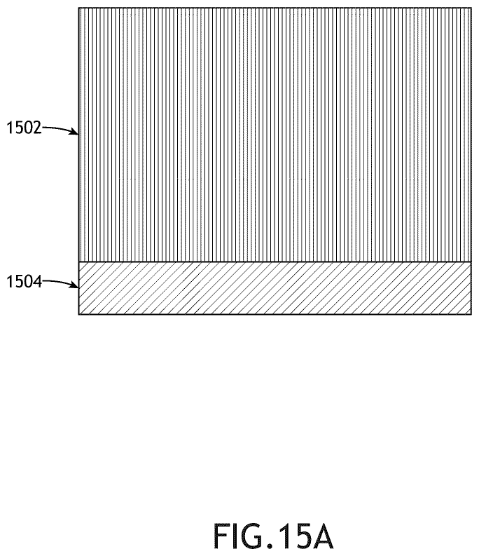

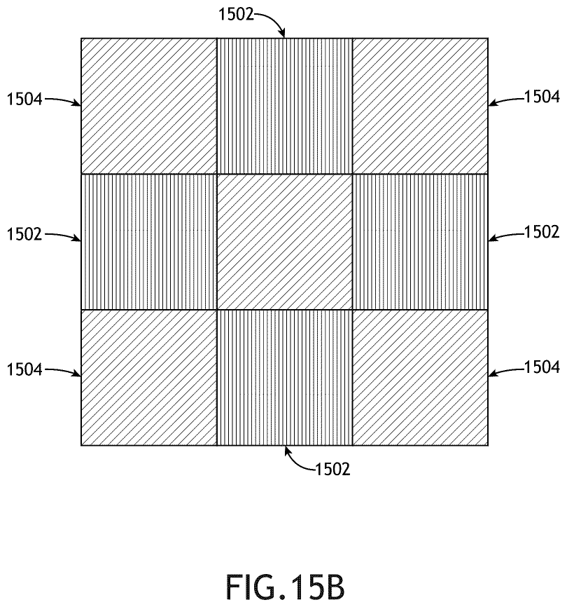

Referring now to FIGS. 14-15, the generation of tailored patterns of surface structures 108 with selected bonding characteristics is described, in accordance with one or more embodiments of the present disclosure.

Surface structures 108 may be fabricated into any desired pattern on a base component 102 by controlling the relative motion between the sample and the laser illumination. The laser processing sub-system 1602 may utilize scanning components such as, but not limited to, motorized stages, galvanometer mirrors, or beam-steering optics to direct the one or more laser beams 1606 across the surface of the base component 102 in a predetermined pattern. By programming the scanning path, surface structures 108 may be selectively formed only in specific regions of the base component 102, allowing for precise spatial control over where bonding enhancement occurs. This capability may enable the creation of complex geometric patterns of surface structures 108 such as, but not limited to, lines, curves, grids, or arbitrary shapes tailored to specific bonding requirements or mechanical loading conditions. The scanning approach may further allow for variation of laser parameters during the patterning process, enabling the formation of surface structures 108 with different morphologies or properties within the same pattern based on local processing conditions.

FIG. 14 illustrates a plot of adhesion strength versus strain for different patterns of the surface structures 108, in accordance with one or more embodiments of the present disclosure. The plot demonstrates that bonding performance may be tailored based on pattern properties such as, but not limited to, a total area of fabricated surface structures 108 or the presence of alternating regions of the surface structures 108 and unprocessed material. Insets in FIG. 14 show images of samples (e.g., the base component 102) prior to bonding for some of the datapoints, illustrating various geometric arrangements of the surface structures 108 across the bonding surface. FIG. 14 illustrates non-limiting examples of how different pattern configurations result in distinct adhesion strength and strain characteristics, with some patterns achieving higher maximum adhesion strengths while others provide greater strain tolerance before failure. The variation in bonding performance across different patterns demonstrates the capability to optimize adhesion properties for specific mechanical loading requirements by controlling the spatial distribution and geometry of the surface structures 108.

The patterning approach shown in FIG. 14 utilizes a single type of the surface structures 108 arranged in different geometric configurations across the bonding area. However, the systems and methods disclosed herein may provide for more complex patterns that incorporate multiple types of the surface structures 108 with different bonding characteristics within the same bonding interface. By varying parameters of incident illumination (e.g., fluence, pulse count, incidence angle, scanning speed across different regions of the base component 102, or the like), distinct types of the surface structures 108 may be fabricated in predetermined locations. This capability enables the creation of hybrid bonding interfaces where different regions provide specialized adhesion properties tailored to anticipated loading conditions. For example, regions expected to experience primarily shear loading may incorporate angled surface structures 108 oriented to resist shear forces, while regions subject to tensile loading may include surface structures 108 optimized for tensile strength.

In some embodiments, multiple patterns of surface structures 108 with different bonding properties are fabricated on a base component 102.

FIGS. 15A-15B illustrate examples of patterned surface designs that incorporate multiple types of the surface structures 108 with different bonding properties, in accordance with one or more embodiments of the present disclosure. FIG. 15A shows a surface of the base component 102 having two patterns of the surface structures 108. The surface includes a primary pattern 1502 and a secondary pattern 1504. Any types of the surface structures 108 with any selected bonding properties may be fabricated in either the first pattern 1502 or the second pattern 1504. For example, the second pattern 1504 may correspond to a shear front and may include angled surface structures 108 pointed against (or along a direction of) an anticipated shear direction, whereas the first pattern 1502 may include a different design of surface features (e.g., normal angle structures) designed to provide tensile and/or torsion resistance. This configuration may allows for directional optimization of bonding performance based on the expected mechanical loading conditions in different regions of the interface 106.

FIG. 15B depicts a checkerboard pattern of alternating the first pattern 1502 and the second pattern 1504 regions arranged in a grid pattern, in accordance with one or more embodiments of the present disclosure. As with FIG. 15A, any type of the surface structures 108 providing any type of bonding characteristics may be used for the first pattern 1502 and the second pattern 1504. This configuration with alternating feature types may provide tailored bonding performance that benefits from multiple types of the surface structures 108 with different bonding characteristics distributed across the bonding interface. The checkerboard arrangement may be particularly advantageous for applications where complex or multi-directional loading conditions are anticipated, as the alternating pattern provides resistance to various types of mechanical stresses throughout the bonded area. The size and spacing of the alternating regions may be adjusted based on the scale of expected loading variations and the desired balance between different types of adhesion properties.

The fabrication of patterned surface designs incorporating multiple types of the surface structures 108 may be achieved through precise control of laser processing parameters during scanning of the base component 102. A laser processing system may be programmed to modify illumination properties such as fluence, pulse count, incidence angle, or scanning speed as the one or more laser beams traverse different regions of the surface. For instance, a first portion of the base component 102 may be irradiated with the one or more laser beams having a first set of illumination properties to form the first pattern 1502 of the surface structures 108, while a second portion of the base component 102 may be irradiated with the one or more laser beams having a second set of illumination properties to form the second pattern 1504 of the surface structures 108. The first set of illumination properties may be selected to provide that the first pattern 1502 of the surface structures 108 has a first set of bonding properties, while the second set of illumination properties may be selected to provide that the second pattern 1504 of the surface structures 108 has a second set of bonding properties. The first set of bonding properties and the second set of bonding properties may differ by at least one of shear strength, tensile strength, or torsion strength, enabling optimization of the bonding interface for specific loading scenarios.

Further, the ability to create complex patterns with multiple types of the surface structures 108 extends beyond simple geometric arrangements to include functionally graded interfaces where bonding properties vary continuously or discretely across the bonding area. Such graded interfaces may be particularly beneficial for applications where stress concentrations or loading gradients are expected, allowing for local optimization of adhesion properties to match anticipated stress distributions. The patterning capability may also enable the creation of bonding interfaces with built-in failure modes, where specific regions are designed to fail preferentially under overload conditions to protect other portions of the hybrid polymer object 100. Additionally, patterns may be designed to provide visual or tactile indicators of bonding quality, where specific arrangements of the surface structures 108 create distinctive surface textures or optical properties that facilitate quality control during manufacturing processes. As an illustration, in some embodiments, patterns may be designed to include regions with intentionally reduced adhesion strength that serve as early failure indicators, providing warning when loading conditions approach levels that could compromise the primary bonding interface. Such sacrificial regions would fail preferentially under increasing stress, alerting operators or monitoring systems to potential overload conditions before critical bond failure occurs.

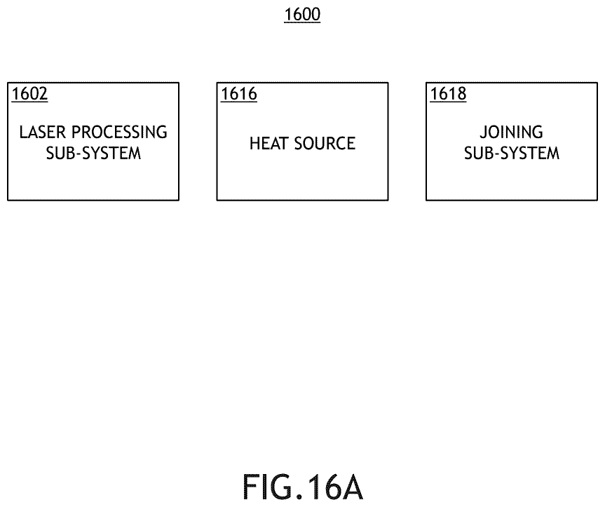

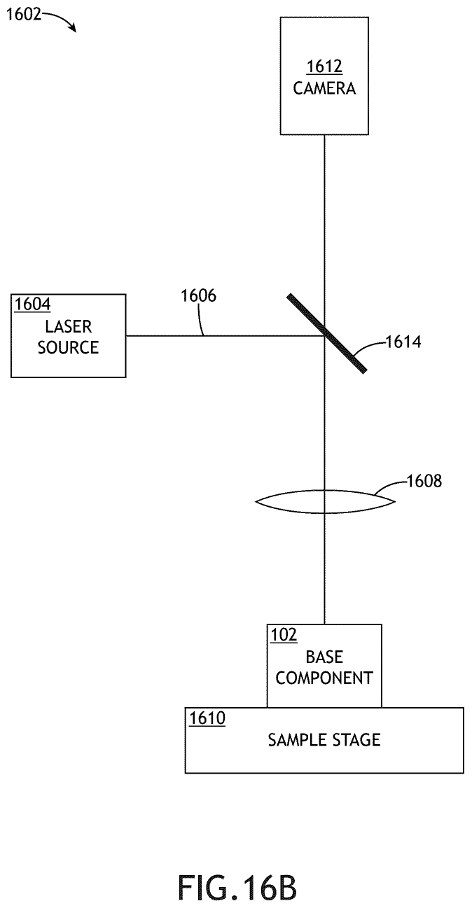

Referring now to FIGS. 16A and 16B, a system 1600 for bonding a polymer to a metal is described, in accordance with one or more embodiments of the present disclosure. For example, the system 1600 may perform one or more steps of the method 200. However, the method 200 is not limited by the system 1600.

FIG. 16A illustrates a block diagram of a system 1600 bonding a polymer to a metal, in accordance with one or more embodiments of the present disclosure. In some embodiments, the system 1600 includes a laser processing sub-system 1602 suitable to irradiate a surface of a base component 102 to form surface structures 108 designed to wick a polymer of interest. In this way, the laser processing sub-system 1602 may implement the step 202 of the method 200.

FIG. 16B illustrates a simplified schematic of the laser processing sub-system 1602, in accordance with one or more embodiments of the present disclosure.

In some embodiments, the laser processing sub-system 1602 includes one or more laser sources 1604 to generate one or more laser beams 1606 and one or more lenses 1608 for focusing the one or more laser beams 1606 to the base component 102. The laser processing sub-system 1602 may further include one or more beam-conditioning components such as, but not limited to, polarizers, spectral filters, neutral density filters, or spatial filters to manipulate various properties of the one or more laser beams 1606.

The one or more laser sources 1604 may include any type of laser sources known in the art suitable for generating laser beams 1606 suitable for inducing surface structures 108 on a base component 102 of interest. Similarly, the one or more laser beams 1606 may have any properties suitable for inducing surface structures 108 on a base component 102 of interest. For example, a laser beam 1606 may include a pulsed beam including one or more laser pulses of any pulse duration including, but not limited to, pulse durations on the order of nanoseconds, picoseconds, femtoseconds, or attoseconds. As an illustration, pulses of a laser beam 1606 may have pulse durations equal to or lower than 1000 nanoseconds, 100 nanoseconds, 10 nanoseconds, 1000 picoseconds, 100 picoseconds, 10 picoseconds, 1000 femtoseconds, 100 femtoseconds, 10 femtoseconds, 1 femtosecond, or lower. A laser beam 1606 may further provide a single pulse, a train of pulses at a fixed repetition rate (e.g., kHz, MHz, or any suitable repetition rate), or one or more bursts of pulses. As another example, a laser beam 1606 may be a continuous-wave (CW) beam. Further, a laser beam 1606 may have any spectral content in any spectral band including, but not limited to, ultraviolet (UV), visible, or infrared (IR) spectral bands.

Further, the one or more laser beams 1606 may be incident on a common location and/or on separate locations of the base component 102. For example, illumination of a common location of the base component 102 may allow for precise control of light-matter interactions necessary to achieve a desired type of surface structures 108. As another example, illumination of separate locations of the base component 102 may provide parallel processing to increase an overall processing speed.

In some embodiments, the laser processing sub-system 1602 includes a sample stage 1610 to secure and position a base component 102 for processing. The sample stage 1610 may provide any number of linear or rotational actuators to provide any number of degrees of freedom.

In some embodiments, the laser processing sub-system 1602 includes one or more scanning components suitable for controlling a position of the base component 102 with respect to the one or more laser beams 1606. In this way, the laser processing sub-system 1602 may fabricate surface structures 108 having any design on all or a portion of the base component 102. For example, a sample stage 1610 may operate as a scanning component and may move the base component 102 with respect to the one or more laser beams 1606. As another example, one or more beam-scanning optics (e.g., galvanometers, f-theta lenses, or the like) may operate as a scanning component and may move one or more laser beams 1606 with respect to the base component 102.

Further, the laser processing sub-system 1602 may direct the one or more laser beams 1606 to the base component 102 at any incidence angles, which may be suitable for, but not limited to, fabricating angled surface structures 108. For example, a sample stage 1610 may adjust an angular orientation of the base component 102 with respect to the one or more laser beams 1606. As another example, the laser processing sub-system 1602 may include one or more mirrors, lenses, or other components to adjust an incidence angle of one or more laser beams 1606.

In some embodiments, the laser processing sub-system 1602 includes a camera 1612 to image at least a portion of the base component 102 (e.g., through a beamsplitter 1614). In this way, the camera 1612 may facilitate positioning and/or monitoring of the base component 102 during the fabrication process.

Referring again to FIG. 16A, the system 1600 may include a heat source 1616 to melt a surface of the polymer component 104. In this way, the heat source 1616 may implement the step 204 of the method 200. The heat source 1616 may include any suitable source of heat including, but not limited to, a hot plate, an oven, a flame, a hot gun, or infrared radiation.

The system 1600 may further include a joining sub-system 1618 to induce contact between the base component 102 and the polymer component 104. In this way, the joining sub-system 1618 may implement the step 206 of the method 200. The joining sub-system 1618 may include any suitable components. For example, the joining sub-system 1618 may include one or more weights. As another example, the joining sub-system 1618 may include a human user. As another example, the joining sub-system 1618 may include one or more automated systems to secure and position the base component 102 and/or the polymer component 104.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A method, comprising:
irradiating a base component with one or more laser beams, wherein one or more properties of the one or more laser beams are selected to induce surface structures on a surface of the base component that wick a polymer component in a molten state into cavities of the surface structures;
heating a surface of the polymer component to create a molten layer; and
joining the surface of the polymer component with the surface of the base component, wherein the molten layer of the polymer component wicks into the cavities of the surface structures of the base component to bond the polymer component to the base component.

2. The method of claim 1, wherein the polymer component comprises:
a least one of polypropylene, a polyolefin or a thermoplastic.

3. The method of claim 1, wherein the base component comprises:
at least one of a metal, a ceramic, a dielectric, or a semiconductor.

4. The method of claim 1, wherein heating the surface of the polymer component to create the molten layer is performed prior to joining the surface of the polymer component with the surface of the base component.

5. The method of claim 1, wherein heating the surface of the polymer component to create the molten layer is performed after joining the surface of the polymer component with the surface of the base component.

6. The method of claim 1, wherein joining the surface of the polymer component with the surface of the base component comprises:
contacting the polymer component with the base component using a pressure equal to or less than 100 bars.

7. The method of claim 1, wherein joining the surface of the polymer component with the surface of the base component comprises:
contacting the polymer component with the base component using a pressure equal to or less than 2 bars.

8. The method of claim 1, wherein the surface structures include at least some features with dimensions smaller than 1000 micrometers and at least some features with dimensions smaller than 1000 nanometers.

9. The method of claim 1, wherein the surface structures are formed from at least one of a same material as the base component or an oxide of a material of the base component.

10. The method of claim 1, wherein irradiating the base component with the one or more laser beams comprises:
irradiating the base component with the one or more laser beams at a non-normal incidence angle and a selected azimuth direction, wherein at least some of the surface structures are oriented in a direction of the non-normal incidence angle.

11. The method of claim 1, wherein irradiating the base component with the one or more laser beams comprises:
irradiating a first portion of the base component with the one or more laser beams having a first set of illumination properties to form a first pattern of the surface structures; and
irradiating a second portion of the base component with the one or more laser beams having a second set of illumination properties to form a second pattern of the surface structures.

12. The method of claim 11, wherein the first set of illumination properties is selected to provide that the first pattern of surface structures has a first set of bonding properties, wherein the second set of illumination properties is selected to provide that the second pattern of surface structures has a second set of bonding properties.

13. The method of claim 12, wherein the first set of bonding properties and the second set of bonding properties differ by at least one of shear strength, tensile strength, or torsion strength.

14. A method, comprising:
irradiating a base component with one or more laser beams, wherein one or more properties of the one or more laser beams are selected to induce surface structures on a surface of the base component that wick a polymer component into cavities of the surface structures, wherein the polymer component includes at least one of a polymer or a precursor to the polymer in a liquid state;
joining the polymer component with the surface of the base component, wherein the polymer component in the liquid state wicks into the cavities of the surface structures of the base component; and
at least one of curing or drying the polymer component while the polymer component is within the cavities of the surface structures to bond the polymer component to the base component.

15. The method of claim 14, wherein at least one of curing or drying the polymer component while within the cavities of the surface structures comprises:
exposing the polymer component to at least one of electromagnetic radiation, heat, pressure, or a catalyst.

16. The method of claim 14, wherein the base component comprises:
at least one of a metal, a ceramic, a dielectric, or a semiconductor.

17. The method of claim 14, wherein the polymer component comprises:
at least one of a thermoset, a paint, a thermoplastic, or an epoxy.

18. The method of claim 14, wherein irradiating the base component with the one or more laser beams comprises:
irradiating the base component with the one or more laser beams at a non-normal incidence angle and a selected azimuth direction, wherein at least some of the surface structures are oriented in a direction of the non-normal incidence angle.

19. The method of claim 14, wherein irradiating the base component with the one or more laser beams comprises:
irradiating a first portion of the base component with the one or more laser beams having a first set of illumination properties to form a first pattern of the surface structures; and
irradiating a second portion of the base component with the one or more laser beams having a second set of illumination properties to form a second pattern of the surface structures.

20. The method of claim 19, wherein the first set of illumination properties is selected to provide that the first pattern of surface structures has a first set of bonding properties, wherein the second set of illumination properties is selected to provide that the second pattern of surface structures has a second set of bonding properties.

21. The method of claim 20, wherein the first set of bonding properties and the second set of bonding properties differ by at least one of shear strength, tensile strength, or torsion strength.

22. A hybrid object, comprising:
a polymer component; and
a base component including surface structures that wick a polymer material in at least one of a molten state or a liquid state into cavities of the surface structures, wherein the polymer component is joined to the base component at an interface with the surface structures.
